(19) United States
(12) Patent Application Publication
(10) Pub. No.: US 2005/0082907 A1
(43) Pub. Date: Apr. 21, 2005

(54) Holding device with moment limiting means for objects to be screwed in components

(76) Inventor: Fritz Neber, Schwaebisch Hall (DE)

Correspondence Address: STRIKER, STRIKER & STENBY, 103 EAST NECK ROAD, HUNTINGTON, NY, 11743, US

(21) Appl. No.: 10/925,200

(22) Filed: Aug. 24, 2004

(30) Foreign Application Priority Data
Oct. 16, 2003 (DE) 103 48 054.4

(51) Int. Cl. B60T 13/66

(52) U.S. Cl. 303/20

(57) ABSTRACT

A holding device with limitation of a moment for objects formed as piston rods to be screwed into components formed as pistons contained in an interior of syringe cylinders, the holding device comprising a holder for an object; a braking device which is formed to non-rotatably hold the holder and, through the holder, the object with a predetermined braking moment, the braking device having an electric brake which acts on the holder.

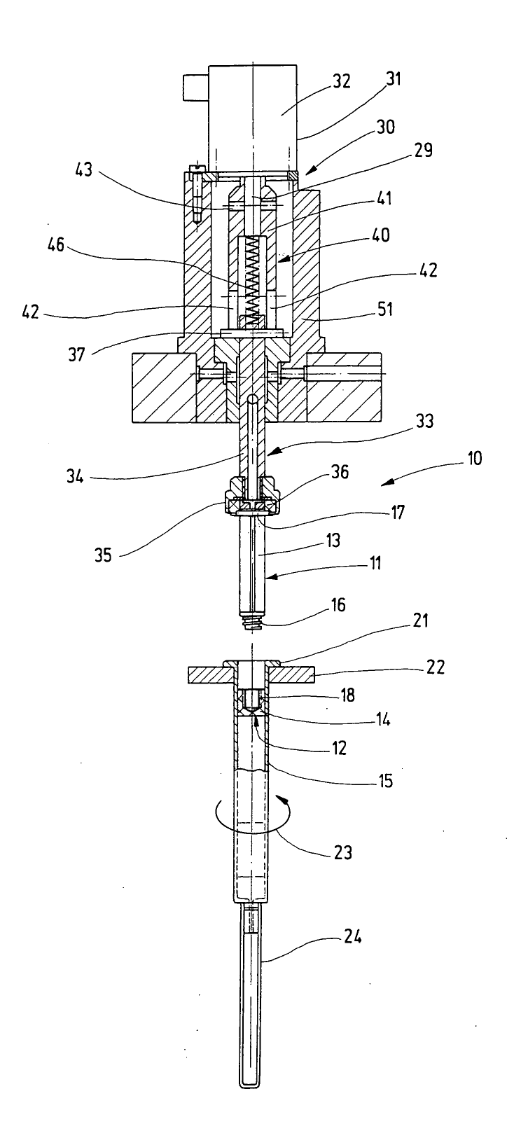

### BACKGROUND OF THE INVENTION

The present invention relates to a holding device with moment limiting means for objects which are to be screwed into components.

Such screwing-in problems take place in many areas, where holding devices are used with limitations of moments. An example of such use is the filling and assembly of medical syringes. Devices are provided for this purpose, in which the individual working steps are performed in an automatic process, for example the filling of the syringe cylinder, subsequently the insertion of the piston in the filled syringe cylinder, and thereafter the screwing of the piston rod into the piston. The pistons are generally composed of synthetic plastic, rubber or similar easily deformable materials.

A holding device of the above mentioned general type is disclosed for example in the German patent document DE 91 08 831. This device has a braking unit with a braking member located on a holder. During turning in, it is brought in contact with the non-rotatable object and non-rotatably fixes the object with a predetermined braking moment. This braking device presses from above against the object to be screwed in, in particular the piston rod, on which an adjustable force is applied by means of a pressure spring that is needed to produce the corresponding braking moment. Because of this axial force which acts on the piston rod in direction of the piston, there are disadvantages during placement of the piston rod on the thread of the piston and screwing-in. There is a danger that the thread of the relatively soft piston jumps over and the piston rotates or is somewhat displaced into the syringe cylinder. Thereby inside the syringe cylinder a certain overpressure can be formed, so that when the user later removes the closing cap which closes the injection cylinder at the lower end of the injection cylinder, the filled product escapes.

### SUMMARY OF THE INVENTION

Accordingly, it is an object of the present invention to provide a holding device of the above mentioned general type, which eliminates the disadvantages of the prior art.

More particularly, it is an object of the present invention to provide a holding device of the above mentioned general type, which is designed so that during screwing-in of the object, in particular the piston rod into a component, in particular a piston, an overspringing of the thread is prevented, and an axial force which acts on the object to be screwed in, acts in a direction toward the component, in particular toward the piston.

In keeping with these objects and with others which will become apparent hereinafter, one feature of the present invention resides, briefly stated, in a holding device with limitation of a moment for objects formed as piston rods to be screwed into components formed as pistons contained in an interior of syringe cylinders, the holding device comprising a holder for an object; a braking device which is formed to non-rotatably hold said holder and, through said holder, the object with a predetermined braking moment, said braking device having an electric brake which acts on said holder.

With the use of the electric brake, it is guaranteed in a simple manner that during screwing-in no overspringing of the thread can occur. Such a braking device in form of an electric brake can be designed in many ways and has many advantages. When compared to a braking device with a sliding clutch, which changes the braking moment in continuous operation over a long time due to the wear, with an electrical braking it is guaranteed that the braking moment remains constant in a continuous operation over a long time.

Since an electrical brake is very simple to control and thereby a change of the braking moment on a way is accessible, the braking moment can be adjusted fast and simple and adapted to different conditions. In piston rod devices which have a plurality of individual stations, for all stations the braking moment can be adjusted centrally and adapted to changing conditions. This is extraordinarily simple and guarantees the same conditions for all stations.

It is further advantageous that practically no axial force acts on the part to be screwed in, in particular on the piston rod, and thereby all disadvantages connected with it are eliminated. During screwing-in of the object into the component, in particular during screwing in of the piston rod into the piston, practically no axial force and no pressure acts on the piston, so that there is no danger of turning or displacement of the piston. The holding device is also simple, compact, space-economical and cost-saving. It includes only a few components.

It is especially advantageous when in accordance with the present invention the braking device has an electric stepper motor. It is not used here with the function of a motor drive, but instead it is in stopping condition and operates as a brake. For this purpose the stepper motor is supplied with a static current of a corresponding magnitude, and thereby a corresponding braking moment is provided. Such stepper motors are commercially available components. They are therefore cost-economical and moreover small, light and compact, so that they are especially suitable for the above mentioned application with special advantages.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically showing an axial longitudinal section with a partial side view of a holding device with moment limiting means for objects to be screwed into components.

### DESCRIPTION OF THE PREFERRED EMBODIMENTS

A holding device in accordance with the present invention is shown with elements which are necessary for this case and identified as a whole with reference numeral 10. The holding device 10 allows to limit a moment for objects 11 which are screwed in components 12.

In the shown embodiment the holding device 10 is a part of a not shown apparatus for filling and assembling an of syringes. The holding device 10 has for example twelve such devices which are arranged on a continuously operating piston rod charging apparatus. In this apparatus as the objects 11, piston rods 13 of the syringes are provided and they must be screwed in the pistons 14 as the components.

The pistons 14 are located inside the syringe cylinder 15 and held on the inner wall of the syringe cylinders 15 by static friction. The piston rod 13 has a lower threaded portion 16, and on the opposite end it has a finger support 17, which here for example is circular and is a component of the piston rod 13. The piston 14 composed of synthetic plastic, rubber and the like, has an inner threaded opening 18. The piston rod 13 must be screwed into the threaded opening 18 with its threaded portion 16.

In the shown embodiment for the screwing-in process, the part 12 which is formed as the piston 14 is rotatably driven in direction which corresponds to the thread course of the threaded opening 18 as shown by the arrow 23. The object 11 formed as the piston rod 13 is held non-rotably relative to it. The syringe cylinder 15 in the illustrated stage is held for example, in a transporting star or the like. The syringe cylinder 15 is placed with its outer surface for example on two not shown rotatably supporting rolls, while on the other side of the syringe cylinder 15 a not shown band moves. The band is in frictional contact with the outer surface of the injection cylinder 15 and is driven in a direction for the rotary drive of the injection cylinder 15 in the arrow direction 23.

The piston 14 which abuts against the inner surface of the syringe cylinder 15 in a frictional manner inside the cylinder is rotatable in the same direction due to driving of the syringe cylinder 15 in a peripheral direction, so that with the stationarily held piston rods 13, it can be screwed with its lower threaded portion 16 into the threaded opening 18 of the piston 14. The syringe cylinder at an upper end is provided in a conventional manner with a web 21. During handling it serves as a finger support. The syringe cylinder 15 is arrested and supported with it in a vertical direction on a schematically shown holding part 22.

The interior of the syringe cylinder 15 is filled, for example, with a liquid product of a predetermined quantity. At the lower end it is closed with a removable closing cap 24, composed for example of rubber.

During screwing-in of the piston rod 13 with its threaded portion 16 into the piston 14 in accordance with a known method and for example by means of a holding device disclosed in the German patent document DE 91 08 831 U1, it is unavoidable that during braking of the piston rod 13 an axial force acts on the latter in direction toward the piston 14. This acts negatively during placement of the piston rod 13 with the threaded portion 16 on the threaded opening 18 of the piston 14. There is a danger that the piston 14 can be pressed deeper into the syringe cylinder 15 and displaced only insignificantly, whereby in the interior of the syringe cylinder 15 a certain overpressure builds up. Such an overpressure results in that the product contained in the syringe cylinder 16 can escape when the user removes the closing cap 24 on the lower end of the syringe cylinder 15. Turning of the piston 14 in the syringe cylinder 15 during screwing-in of the piston rod 13 is disadvantageous.

In another known holding device with a braking unit in form of a sliding coupling, the elements of the sliding coupling are subjected to wear in form of friction and the like, and as a result the magnitude of the provided braking moment changes during a continuous operation over a long time. The braking moment must be individually adjusted for the individual stations, for example when differently sized objects 11, in particular piston rods 13, must be screwed into the corresponding pistons 14 of the syringe cylinders 15. During screwing-in of the piston rods 13 with the threaded portion 16 in the threaded opening 18 of the piston 14, there is also a danger that with the soft material of the piston 14 it springs over this thread.

The above mentioned disadvantages are eliminated by the holding device 10 in accordance with the present invention. The holding device 10 has a holder 33 for the non-rotatable object 11, in the shown embodiment for the non-rotatable piston rod 13, and is provided with a braking unit 30 which holds this holder 33 non rotatably and through the latter also the object 11, or in the shown embodiment the piston rod 13, with a predetermined braking moment Mt1. This braking unit 30 in a special design has an electric brake 31 which acts on the holder 33. This electrical brake 31 can be designed in many ways, for example it can be designed as a rotor which is held in a magnetic field of a predetermined magnitude as a hysteresis coupling, as an eddy current brake, etc.

It is especially advantageous when such an electric brake 31 is formed as an electric stepper motor 32. Such stepper motors are commercially available and can be purchased as finished components. They are cost-favorable, small and light and are extremely efficient as electric brakes 31. In the holding device 10 of this type, these electrical stepper motors 32 are not used for a rotary drive, for which they are designed, but instead as the electrical brake 31. The corresponding stepper motor 32 is supplied with a steady current of a corresponding magnitude and located in stopped condition. It however limits the torque during screwing-in of the corresponding piston rod 13 in the piston 14.

When the braking moment Mt1 provided by the magnitude of the static current is exceeded, the stepper motor 32 by means of the holder 33 is rotated in an opposite direction to the driving direction. The produced braking moment Mtl practically does not have an axial force acting in direction toward the piston 14, which is applied to the piston rod 13. During placing of the threaded portion 16 on the threaded opening 18 of the piston 14 and screwing-in into it, no pressure is applied to the piston 14. Thereby it is prevented that during screwing-in the piston 14 is rotated in the syringe cylinder 15 and is displaced. Furthermore, during screwing-in an overspringing of the thread of the piston 14 is prevented.

The holder 33 has a plunger 34 with a pickup head 35 for the objects 11 to be fixedly held, in particular forthe piston rods 13. The plunger 34 is arranged substantially coaxially to said piston rod 13 and is held in a conventional manner displaceably, but non-rotatably. The pickup head 35 is provided with a vacuum holder 36 of a conventional type for an end part, in particular the finger support 17, of the object 11 to be held stationary. The details of the pickup head 35 and the vacuum holder 36 do not need to be described. A reference is made with respect to these parts, for example to the above mentioned German patent document DE 201 04 435 U1.

The holder 33 further has a transmission member 40 which is connected with the braking unit 30 for joint rotation and axial displacement, and formed for example as a sleeve 41. The transmission member 40 is connected non-rotatably but axially displaceably relative to the plunger 34. It extends substantially coaxial to the plunger 34. For this connection, the plunger 34 has a transverse pin 37, with its pin ends engaging in associatedvertical slots 42 of the sleeve 41 in a form-locking manner, but is relatively axially displaceable. In the region of the other end the sleeve 41 is held centered on a drive pin 29 of the electric brake 31, and is connected by means of a transverse pin with the drive pin 29 form-lockingly in the peripheral direction. A pressure spring 46 is arranged in an axial region between the sleeve 41 and the plunger 34. With its ends it is supported on the sleeve 41 and on the plunger 34, and during the relative displacement of both parts provides equalization of the holder 33.

The holder 33, in particular its plunger 34 and the transmission member 40, are located inside a housing 51. The electric brake 31 is mounted on the upper end of the housing 51 releasably and so that its drive pin 29 engages into the housing 51. The housing 51 with all components which are held on, is movable in direction toward the syringe cylinder 15 and opposite to it.

The holding moment Mt2 which acts in the region of the pickup head 35 between it and the finger support 17 is greater than the braking moment Mt1 of the braking unit 30, whose magnitude is provided by the static current, with which the stepper motor 32 is supplied. The torque limiting is performed with the electric stepper motor 32 via this current limiting. This design has numerous advantages. An electric stepper motor 32 is available as a finished component and can be purchased and therefore is cost-favorable, small and light. Its braking moment Mt1 remains constant in a continuous operation over a long time. It is especially advantageous that for all stations of a continuously operating piston rod inserting apparatus the corresponding braking moment can be adjusted centrally by a central supply of the static current.

The single adjustment of the braking moment for all stations can be fast and simple to execute. When in the above described apparatus the piston rods 13 of different sizes must be processed, then for all stations the corresponding braking moment can be adjusted centrally. It is also guaranteed that during screwing-in of the piston rod 13 into the piston 14, practically no axial force acts on the piston rod 13 in direction toward the piston 14, and thereby no pressure is applied to the piston 14. It is therefore prevented that the piston 14 during screwing-in can be conventionally turned or axially displaced. To the contrary, it is counteracted in such a manner that due to the vacuum holder 36 and the pickup head 35 the piston rod 13 is pulled upwardly in the axial direction which is opposite to the piston 14.

It will be understood that each of the elements described above, or two or more together, may also find a useful application in other types of constructions differing from the types described above.

While the invention has been illustrated and described as embodied in holding device with moment limiting means for objects to be screwed in components, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A holding device with limitation of a moment for objects formed as piston rods to be screwed into components formed as pistons contained in an interior of syringe cylinders, the holding device comprising a holder for an object; a braking device which is formed to non-rotatably hold said holder and, through said holder, the object with a predetermined braking moment, said braking device having an electric brake which acts on said holder.

2. A holding device as defined in claim 1, wherein said braking device has an electric stepper motor.

3. A holding device as defined in claim 1, wherein said holder has a plunger provided with a pickup head for the objects formed as the piston rods.

4. A holding device as defined in claim 3, wherein said pickup head is provided with a vacuum holder for an end part formed as a finger support of the object formed as a piston rod.

5. A holding device as defined in claim 3, wherein said holder has a transmission member which is connected with said braking device for joint rotation and axial displacement and also connected with said plunger for joint rotation but axially displaceably relative to said plunger.

6. A holding device as defined in claim 5, wherein said transmission member is formed as a sleeve.

7. A holding device as defined in claim 5; and further comprising a pressure spring arranged between said transmission member and said plunger.

8. A holding device as defined in claim 5; and further comprising a housing accommodating said plunger of said holder and said transmission member.

9. A holding device as defined in claim 8, wherein said braking device is attached to said housing at an end which faces away from said pickup head of said holder.

10. A holding device as defined in claim 9, wherein said braking device engages with a drive pin in said housing.
